(19) United States
(12) Patent Application Publication
(10) Pub. No.: US 2007/0049370 A1
(43) Pub. Date: Mar. 1, 2007

(54) Simulation program, recording media, simulator, gaming machine and game network system

(75) Inventor: Hiroyuki Watanabe, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/377,637

(22) Filed: Mar. 17, 2006

(30) Foreign Application Priority Data
Aug. 30, 2005 (JP) 2005-249907

(51) Int. Cl. A63F 9/24; A63F 13/00; A63D 3/02

(52) U.S. Cl. 463/16; 463/43; 273/120 R

(57) ABSTRACT

A simulation program according to the present invention allows a computer to execute: a first displaying step of displaying at least one portion of a virtual pachinko machine on a display screen of the computer, based upon gaming board information relating to a gaming board having a predetermined gaming area and gaming element arranged on the gaming board; an altering step of making the gaming board information alterable; a material parameter setting step of setting parameters relating to materials of the gaming board and the gaming elements; an orbit calculating step of calculating an orbit of a gaming ball on the gaming board to be launched onto the gaming board based upon the parameters and the gaming board information; and a second displaying step of displaying the orbit of a gaming ball calculated in the orbit calculating step on the gaming board.

### CROSS-REFERENCE TO RELATED APPLICATIONS

The present application relates to Japanese Patent Application No. 2004-380967, filed on Dec. 28, 2004 and Japanese Patent Application No. 2005-249907, filed on Aug. 30, 2005. The contents of these applications are incorporated herein by reference in their entirety.

### BACKGROUND OF THE INVENTION

1. Field of the Invention

The present invention relates to a simulation program for simulating operations of a gaming machine based upon predetermined parameters and a recording media that records such a program, as well as a simulator, a gaming machine and a game network system capable of executing the program.

2. Discussion of the Background

In general, upon designing a gaming machine, for example, a pachinko gaming machine, a gaming board of a pachinko gaming machine is actually manufactured, and orbits of gaming balls on the gaming board are examined by launching gaming balls onto the gaming board so that based upon the results, a final layout and the like of each of gaming elements (such as nails, game-starting accessories, windmills and starting openings) on the gaming board are determined.

In this method, however, in an attempt to alter the layout or the like of each of the gaming elements, the gaming board needs to be again manufactured and the orbits of gaming balls need to be reexamined; therefore, many time consuming tasks are required for designing the pachinko gaming machine.

In order to solve this problem, JP-A 2000-218029 has proposed a pachinko machine simulator on which the layout of gaming elements at a desired position on a gaming board can be designed, and the orbit of each of gaming balls on the gaming board can be simulated without the necessity of actually manufacturing a gaming board.

At present, various materials are used for the gaming board and the gaming elements of a pachinko gaming machine. However, since the materials of a pachinko gaming machine fail to be taken into consideration in JP-A 2000-218029, the orbits of simulated gaming balls may be much different from orbits of the gaming balls of an actual pachinko gaming machine.

Moreover, on the pachinko machine simulator disclosed in JP-A 2000-218029, it is impossible to simulate an orbit of a gaming ball in a place other than on the gaming board. In fact, gaming balls are allowed to flow down in places other than on the gaming board, and upon designing a gaming machine, it is also indispensable in the design of a gaming machine to verify the flow-down behavior thereof.

For example, in an actual pachinko gaming machine, all the gaming balls to be paid out for the player through a prize ball payout passage (a passage for paying out gaming balls as prize balls upon accepting a gaming ball into a predetermined winning area on a gaming board) need to be discharged to an upper tray; however, when gaming balls are discharged to a lower tray even in the case where the upper tray is not filled with gaming balls, a smooth progress of the game is disturbed, and it is considered that any error might exist in the designing of the prize ball payout passage. In such a case, with the conventional procedure in which a prototype of a gaming machine needs to be formed so as to examine the flow-down behavior of gaming balls, the trouble (designing error) with the flowing-down gaming balls is examined and a prototype needs to be again manufactured to cause the resulting high developing costs (that is true for JP-A 2000-218029 in which it is impossible to simulate the orbit of a gaming ball in a place other than on the gaming board).

Moreover, in an actual pachinko gaming machine, in the case where the upper tray is filled with gaming balls, one portion of gaming balls on the upper tray are allowed to be discharged onto the lower tray; therefore, upon designing, it is necessary to also examine whether or not a passage that extends from the upper tray to the lower tray is clogged with gaming balls so as to maintain a smooth progress of the game without troubles. However, upon occurrence of clogging with gaming balls during the prototype manufacturing stage, the above-mentioned conventional designing mode needs to have a change in designing processes of the prototype (the prototype has to be again manufactured), inevitably resulting in high developing costs.

Moreover, in the pachinko machine simulator disclosed in JP-A 2000-218029, although the orbit of a gaming ball on the gaming board can be simulated, it is not possible to obtain statistical data on the results of the games. Consequently, the designer has to determine the final layout and the like of gaming elements on the gaming board based upon his or her experience. In other words, even when the pachinko machine simulator is used, it is still difficult for an inexperienced designer to design a pachinko gaming machine.

The contents of JP-A 2000-218029 are incorporated by reference herein in their entirety.

### SUMMARY OF THE INVENTION

The present invention has been devised to solve the above-mentioned problems, and its objective is to provide a simulation program that can calculate a ball orbit that is remarkably similar to that of an actual pachinko gaming machine, can cut developing costs by reducing the number of prototype manufacturing processes and allows even a beginner to easily design a gaming machine, and a simulator and the like for such a simulation program.

In order to solve the above-mentioned problems, a first aspect of the present invention provides the following configurations.

(1) A pachinko machine simulation program allows a computer to execute: a first displaying step of displaying at least one portion of a virtual pachinko machine on a display screen of the computer, based upon gaming board information relating to a gaming board having a predetermined gaming area and a gaming element arranged on the gaming board; an altering step of making the gaming board information alterable; a material parameter setting step of setting parameters relating to materials of the gaming board and the gaming element; an orbit calculating step of calculating an orbit of a gaming ball on the gaming board to be launched onto the gaming board based upon the parameters and the gaming board information; and a second displaying step of displaying the orbit of a gaming ball calculated in the orbit calculating step on the gaming board.

According to the pachinko machine simulation program of the configuration (1), since parameters relating to materials for the gaming board and a gaming element are used upon calculating the orbit of a gaming ball on the gaming board, it is possible to calculate a ball orbit that is remarkably similar to that of an actual pachinko gaming machine.

(2) In the pachinko machine simulation program according to the configuration (1), the parameters include a coefficient of friction or a coefficient of restitution between the gaming ball and the gaming element.

In accordance with the pachinko machine simulation program of the configuration (2), the same functions and effects as those of the pachinko machine simulation program of the configuration (1) are obtained, and since physical values that are directly related to the materials of the gaming board and the gaming element are incorporated into the orbital calculations so that ball orbits that are remarkably similar to those of an actual pachinko gaming machine can be effectively calculated in an efficient manner.

(3) The pachinko machine simulation program according to the configuration (1) further comprises a parameter altering step of making the parameters alterable.

In accordance with the pachinko machine simulation program of the configuration (3), the same functions and effects as those of the pachinko machine simulation program of the configuration (1) are obtained, and since the parameters that relate to the materials of the gaming board and the gaming element can be altered, the convenience of a change of design is improved.

(4) In the pachinko machine simulation program according to the configuration (1), the gaming board information includes any one of a launching velocity of a gaming ball, a tilt angle of the gaming board, and a shape, a position and a size of the gaming element.

In accordance with the pachinko machine simulation program of the configuration (4), the same functions and effects as those of the pachinko machine simulation program of the configuration (1) are obtained, and since parameters that give influences to the orbit of the gaming ball on the gaming board are included as gaming board information, operations of the gaming ball that are remarkably similar to those of an actual gaming ball can be simulated so that the reliability of an orbital calculation of a gaming ball can be further improved. Moreover, pieces of information that are indispensable for designing a gaming board are incorporated as the gaming board information, which can be helpful to the design of the gaming board.

Moreover, the first aspect of the present invention also provides a recording media in which the pachinko machine simulation program of any one of the configurations (1) to (4) is recorded, as well as a simulator, a pachinko gaming machine and a game network system in which the program can be executed.

Moreover, a second aspect of the present invention provides the following configurations.

(5) A simulation program for allowing a computer to execute: a member information setting step of setting member information relating to respective members constituting a gaming machine; an arranging step of arranging a simulated gaming machine in a virtual space based upon the member information set in the member information setting step; an orbit calculating step of calculating an orbit of a simulated gaming medium flowing down in the simulated gaming machine in the virtual space based upon the member information; and a displaying step of displaying an image in which the simulated gaming medium flows down on the simulated gaming machine with the display means based upon the orbit of the simulated gaming medium calculated in the orbit calculating step.

In accordance with the simulation program of the configuration (5), an orbit of a simulated gaming medium flowing down in the simulated gaming machine in the virtual space is calculated based upon the member information constituting the gaming machine, and based upon the calculated orbit, an image in which the simulated gaming medium is allowed to flow down on the simulated gaming machine is displayed with the display means so that the orbit of the gaming medium can be recognized in advance at the pre-stage of the actual manufacturing process of a gaming machine. Therefore, it is not necessary to actually manufacture a prototype or the like of the gaming machine and conduct examining processes thereon, thereby making it possible to greatly cut the developing costs of the gaming machine.

In the above-mentioned configurations, the simulated gaming machine refers to a simulated display of the entire portion or one portion of a pachinko gaming machine or the like displayed in a virtual space, and the virtual space refers to a working area (for example, RAM) in which, for example, data relating to the simulated gaming machine based upon member information is expanded. Moreover, in the above-mentioned configurations, the simulated gaming medium refers to data relating to the gaming medium expanded in the virtual space, and with respect to the gaming media, for example, balls and medals can be used.

Moreover, in the above-mentioned configurations, in the case of a pachinko gaming machine, examples of members constituting the gaming machine include: gaming elements on the gaming board (for example, nails, game-starting accessories, windmills, starting openings and the like) and various portions (prize ball payout passages and the like) constituting the gaming machine.

Furthermore, in the above-mentioned configurations, in the case of a pachinko gaming machine, examples of the member information include: game board information relating to a gaming board having a predetermined gaming area and the gaming element arranged on this gaming board and parameters (for example, parameters relating to materials of the gaming board and the gaming elements) that affect orbits of gaming balls on the gaming board. By properly setting/altering the member information in the member information setting step, it is possible to enhance the reliability of orbit calculations of the gaming medium.

(6) In the simulation program according to the configuration (5), in the member information setting step, numeric value information relating to a coefficient of restitution or a coefficient of friction is settable for each of the members.

In accordance with the simulation program of the configuration (6), the same functions and effects as those of the simulation program of the configuration (5) are obtained, and the orbit of the gaming ball can be examined by taking changes in physical properties of the members due to the environmental factors such as humidity and temperature into consideration. In the above-mentioned configuration, for example, in the case of a pachinko gaming machine, the numeric value information relating to a coefficient of restitution or a coefficient of friction includes the coefficient of restitution and the coefficient of friction between the gaming ball and the gaming element.

(7) In the simulation program according to the configuration (5), in the member information setting step, a layout position of a member is settable for each of the members.

In accordance with the simulation program of the configuration (7), the same functions and effects as those of the simulation program of the configuration (5) are obtained, and the orbit of the gaming medium can be examined by changing the layout position of each of the members so that it becomes possible to improve the reliability of orbital calculations of a gaming medium. In the above-mentioned configuration, “the layout position” includes the tilt angle of each of the members. Moreover, when information, such as “the layout position of each member”, that is indispensable for designing a gaming machine is incorporated, the designing of a gaming machine can be easily carried out desirably.

(8) In the simulation program according to the configuration (5), in the member information setting step, a form of a member is settable for each of the members.

In accordance with the simulation program of the configuration (8), the same functions and effects as those of the simulation program of the configuration (5) are obtained, and the orbit of the gaming medium can be examined by changing the form of each of the members so that it becomes possible to improve the reliability of orbital calculations of a gaming medium. In the above-mentioned configuration, “the form” includes the shape and the size of each of the members.

(9) The simulation program according to the configuration (5) further comprises a gaming medium information setting step of setting information relating to the simulated gaming medium.

In accordance with the simulation program of the configuration (9), the same functions and effects as those of the simulation program of the configuration (5) are obtained, and since information relating to a simulated gaming medium can be set, it becomes possible to carry out the designing process by taking into consideration, for example, changes in physical properties due to the material of the gaming medium and the environment, and the flowing speed of the gaming medium. Here, for example, in the case of a pachinko gaming machine, “the information relating to the simulated gaming medium” includes the launching speed of the gaming ball. The launching speed of the gaming ball is a parameter that gives influences to the orbit of the gaming ball on the gaming board, and by incorporating this parameter as information relating to the simulated gaming medium, it becomes possible to reproduce an operation remarkably similar to the actual operation of a gaming ball, and consequently to further improve the reliability of orbital calculations of a gaming ball. Here, in the case of a pachinko gaming machine, for example, “the information relating to the simulated gaming medium” may include information for changing the velocity of the gaming ball. In such a case, many-sided designing processes of the gaming board in association with the velocity of a gaming ball can be carried out, which is effective.

(10) The simulation program according to the configuration (5) further comprises: an accumulating step of accumulating a predetermined statistical value relating to the result caused by the simulated gaming medium to the simulated gaming machine based upon the orbit of the simulated gaming medium calculated in the orbit calculating step; and an accumulated result displaying step of displaying the result accumulated in the accumulating step.

In accordance with the simulation program of the configuration (10), the same functions and effects as those of the simulation program of the configuration (5) are obtained, and the final layout and the like of each of the members can be determined based upon the orbit of the simulated gaming medium and the statistical values thus displayed, which allows even a beginner to easily design a pachinko gaming machine, and consequently to reduce the number of processes upon forming prototypes of the gaming machine. Moreover, the statistical values allow the designer to confirm the trend of influences given by the gaming medium to the gaming machine, and consequently to further improve the developing efficiency of a gaming machine.

Here, in the above-mentioned configuration, for example, in the case of a pachinko gaming machine, “the result given by the simulated gaming medium to the simulated gaming machine” includes the result caused by the fact that a gaming ball has entered a predetermined winning area on a gaming board. Moreover, in the above-mentioned configuration, in the accumulating step, predetermined statistical values relating to the results of games are preferably calculated by repeating the orbit calculating step and the displaying step, with parameters that give influences to the orbits of simulated gaming media (gaming media) being changed. Thus, the reliability of calculations on statistical values can be improved. Moreover, in the above-mentioned configuration, “the launching velocity of the gaming ball”, described in the configuration (5), maybe randomly changed in the accumulating step. In this case, it becomes possible to make the orbits of the gaming balls dispersed, and consequently to reproduce an operation remarkably similar to the actual operation of a gaming ball. Therefore, it becomes possible to further improve the reliability of orbital calculations and calculations of statistical values of a gaming ball.

(11) In the simulation program according to the configuration (10), in the orbit calculating step, the orbit of the simulated gaming medium on the gaming board placed in the simulated gaming machine can be calculated, the program further comprises a winning determining step of determining a passage of a simulated gaming medium through a predetermined winning determination area on the gaming board as a winning, and in the accumulating step, the ratio of the number of determined winnings to the total number of the simulated gaming media that flow down on the gaming board is calculated.

In accordance with the simulation program of the configuration (11), the same functions and effects as those of the simulation program of the configuration (10) are obtained, and since the layout of the members can be made based upon the so-called “winning rate”, the designing of a gaming board with a predetermined winning rate can be easily carried out.

(12) In the simulation program according to the configuration (11), a plurality of the winning determination areas are prepared, the program further comprises a point setting step of setting a point for each of the winning determination areas, and in the accumulating step, points are added in accordance with a winning determination area through which a simulated gaming medium has passed so that an accumulated value is calculated, with the ratio of the accumulated value of the points to the total number of the simulated gaming media that flow down on the gaming board being calculated.

In accordance with the simulation program of the configuration (12), the same functions and effects as those of the simulation program of the configuration (11) are obtained, and since the layout of member scan be made based upon the so-called “ball payout rate”, the designing of a gaming machine with a predetermined ball payout rate can be easily carried out.

Moreover, the second aspect of the present invention also provides a simulator capable of executing the simulation program of any one of the configurations (5) to (12).

In accordance with the present invention, it becomes possible to calculate a ball orbit that is remarkably similar to that of an actual pachinko gaming machine, to cut developing costs by reducing the number of prototype manufacturing processes and also to allow even a beginner to easily design a gaming machine.

### BRIEF DESCRIPTION OF THE DRAWINGS

FIG. 1 is a block diagram showing a schematic structure of a pachinko machine simulator in accordance with one embodiment of the first aspect of the present invention;

FIG. 2 is a flowchart that shows controlling processes of the simulator in FIG. 1;

FIG. 3 is a flowchart that shows computing processes of the simulator in FIG. 1;

FIG. 4 illustrates one example of a layout image of a gaming board of the pachinko gaming machine displayed on the screen of a display device;

FIG. 5 illustrates another example of a layout image of a gaming board of the pachinko gaming machine displayed on the screen of a display device;

FIG. 6 illustrates a state in which a gaming element on the layout image of FIG. 4 is moved through drag and drop processes;

FIG. 7 illustrates one example of the orbit of a gaming ball displayed on the layout image of FIG. 4;

FIG. 8 shows one example of a winning rate list;

FIG. 9 shows an example of a setting display for coefficient of restitution and coefficient of friction between the gaming ball and each of various gaming elements;

FIG. 10 is an external view that shows a pachinko gaming machine;

FIG. 11 is a schematic diagram that shows one example of a mode in which a computer reads a processing program of the simulator of FIG. 1 stored in a storage media and executes the program;

FIG. 12 illustrates one example of a game network system on which the functions of the simulator of FIG. 1 is realized;

FIG. 13 is a block diagram that schematically shows a structure of a pachinko machine simulator in accordance with another embodiment of the present invention;

FIG. 14 is a flowchart that shows a controlling process of the simulator of FIG. 13;

FIG. 15 is a flowchart that shows orbit computing processes of the simulator of FIG. 13;

FIG. 16 illustrates one example of a layout image of a gaming board of a pachinko gaming machine displayed on the screen of a display device; and

FIG. 17 shows an example of a setting display for coefficient of restitution and coefficient of friction between the gaming balls as well as between the gaming ball and each of prize ball paths.

### DESCRIPTION OF THE EMBODIMENTS

The following description will discuss a first aspect of the present invention and a second aspect of the present invention. Here, unless otherwise specified, when simply referred to as the present invention, this case includes both the first aspect of the present invention and the second aspect of the present invention.

### First Embodiment

Referring to the drawings, the following description will discuss one embodiment of the first aspect of the present invention.

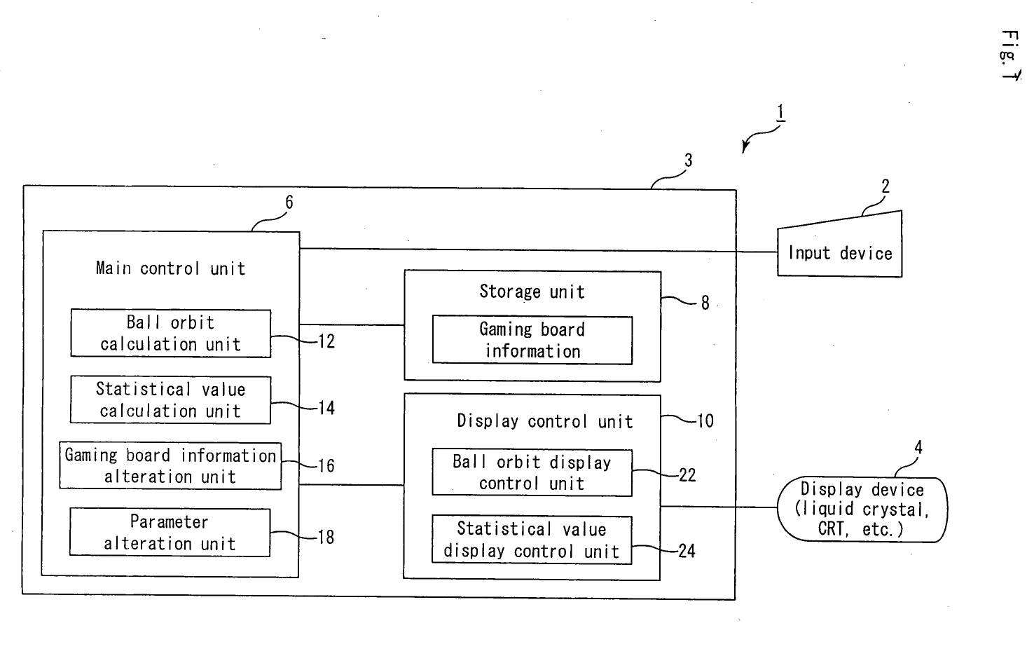

FIG. 1 shows a schematic structure of a pachinko machine simulator 1 in accordance with one embodiment of the first aspect of the present invention. Here, this simulator 1 is mainly used for designing a pachinko gaming machine; however, this may be manufactured as a pachinko gaming machine that also provides gaming characteristics. For convenience of explanation, the following description will discuss a case in which the simulator 1 is applied to a designing process for a pachinko gaming machine in detail.

As shown in FIG. 1, the simulator 1 mainly comprises a simulator main body 3 constituting a computer, an input device 2 and a display device (display means) 4. Here, in FIG. 1, the input device 2 and the display device 4 are indicated in a separate manner from the simulator main body 3; however, these may be formed as integral parts with the simulator main body 3.

The simulator main body 3 is provided with a main control unit 6 that controls various operations of the simulator 1, a storage unit 8 as storage means, which stores gaming board information relating to a gaming board of the pachinko gaming machine having a predetermined gaming area and gaming elements (nails, windmills, game-starting accessories and the like) that are placed on the gaming board, and a display control unit 10 that carries out a display control on the display device 4 based upon a control signal from the main control unit 6.

Moreover, the input device 2 comprises a keyboard, a mouse or other optional switches (including a controller as used for various domestic gaming machines), is connected to the main control unit 6, and used for inputting signals that set or alter parameters that give influences to the gaming board information and orbits of gaming balls on the gaming board to the main control unit 6. In other words, the input device 2 functions as alteration means for altering the game board information, and also functions as parameter setting means and parameter alteration means for setting or altering the parameters. Here, since the parameters include parameters relating to materials of the gaming board and the gaming elements as will be described later, the input device 2 is also allowed to function as material parameter setting means.

Moreover, the display device 4, which comprises various conventionally-known display devices such as liquid crystal devices and CRT devices, can display at least one portion of a virtual pachinko gaming machine based upon the above-mentioned gaming board information.

The main control unit 6 is provided with a ball orbit calculation unit (computation means) 12 that calculates orbits on the gaming board of gaming balls to be launched onto the gaming board based upon the gaming board information stored in the storage unit 8. Here, the display control unit 10 is provided with a ball orbit display control unit (simulation means) 22 for simulating the orbits of gaming balls calculated by the ball orbit calculation unit 12 on the display device 4. In other words, the ball orbit calculation unit 12 and the ball orbit display control unit 22 constitute operation simulation means for carrying out orbit calculations of gaming balls and simulated displaying operations, in cooperation with each other.

The main control unit 6 is provided with a statistical value calculation unit 14 that calculates predetermined statistical values relating to the results of games by repeating the orbit calculations and the simulating processes with parameters that give influences to the orbits of gaming balls on the gaming board being changed. Here, the display control unit 10 is provided with a statistical value display control unit 24 that displays statistical values calculated in the statistical value calculation unit 14 on the display device 4. In the first embodiment, the statistical value calculation unit 14 and the statistical value display control unit 24 are installed in a separated manner from the ball orbit calculation unit 12 and the ball orbit display control unit 22 that constitute the operation simulation means; however, these may form the operation simulation means in cooperation with the ball orbit calculation unit 12 and the ball orbit display control unit 22.

Moreover, the main control unit 6 is provided with a gaming board information alteration unit 16 that alters the gaming board information based upon a signal inputted from the input device 2 and a parameter alteration unit 18 that alters the parameters in accordance with a predetermined program inside the main control unit 6 or alters the parameters based upon a signal inputted from the input device 2.

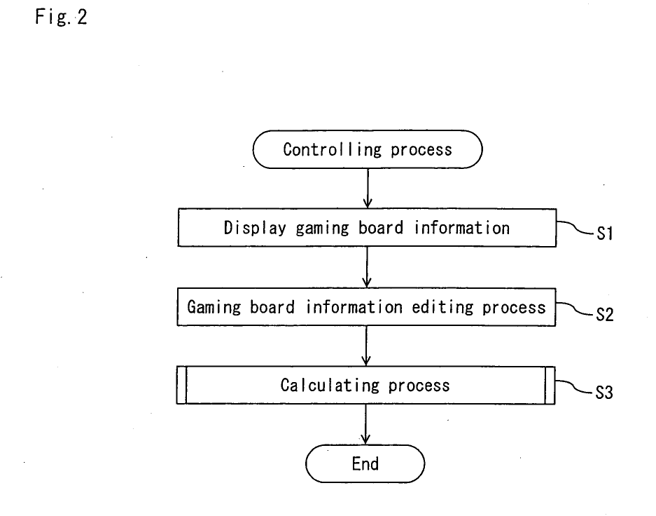

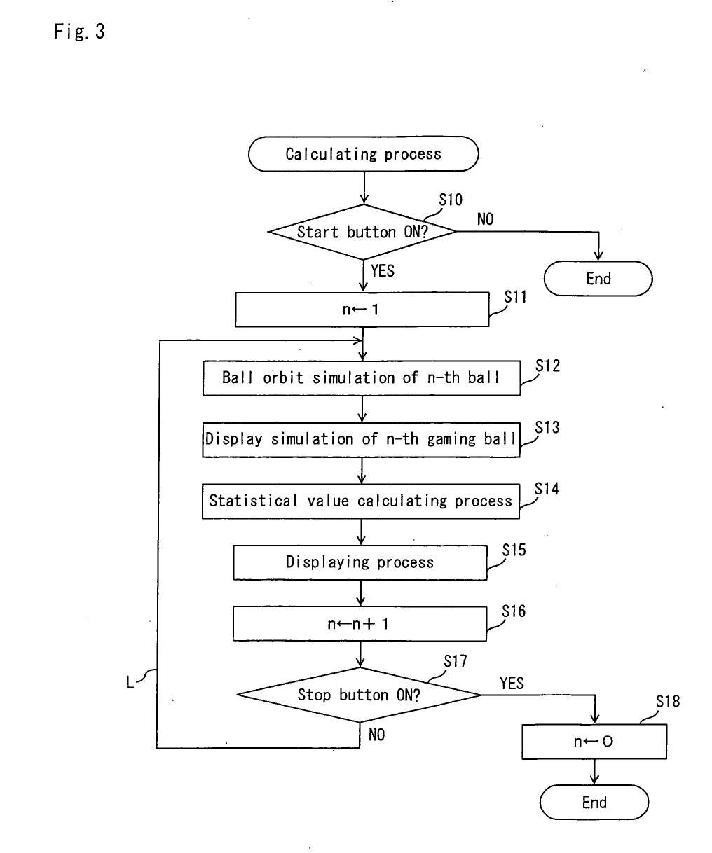

Next, referring mainly to FIG. 2 and a flowchart of FIG. 3, the following description will discuss a designing operation of a pachinko gaming machine by using the simulator 1 having the above-mentioned structure, in detail.

As shown in the flowchart of controlling processes of FIG. 2, in step S1, gaming board information is displayed on the screen of the display device 4 (first displaying step). This step is carried out, for example, by turning on the power supply of the simulator main body 3 of the simulator 1 and by operating a predetermined key or switch of the input device 2. Or, in the case where the input device 2 is a mouse, a pointer is set at a predetermined item displayed on the screen of the display device 4 and the mouse is left-clicked upon turning on the power supply; thereby the game board information can be displayed on the display device 4. Of course, another mode in which an application program stored in the storage unit 8 is started so that the game board information is loaded from a predetermined file may be adopted.

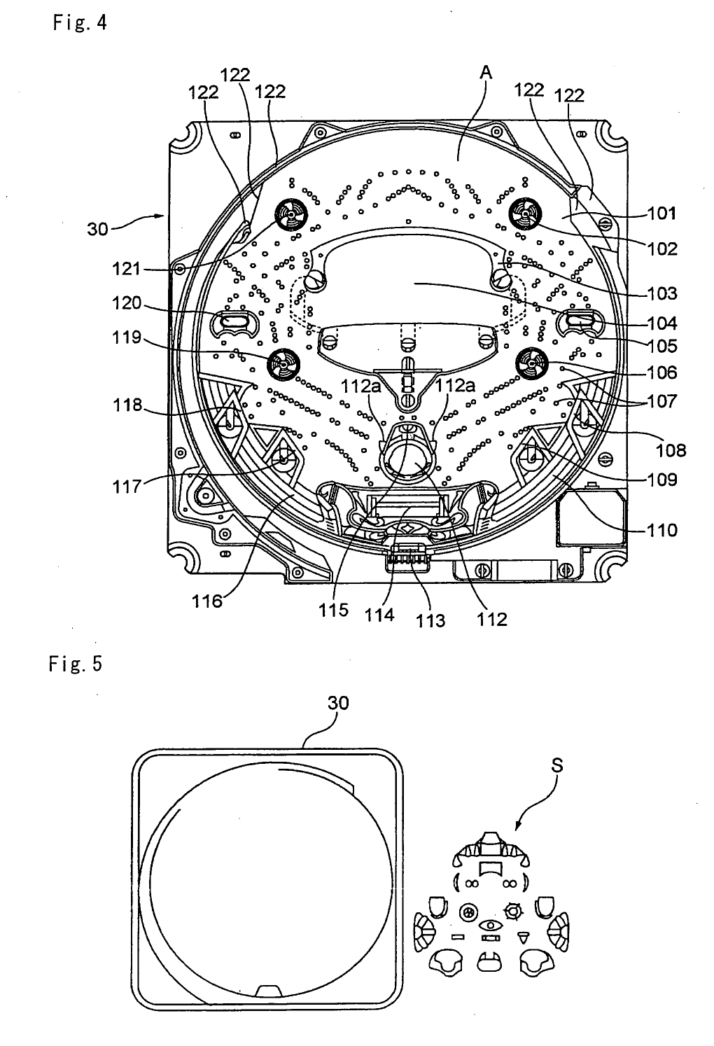

FIG. 4 shows one example in which the game board information is displayed on the display device 4. In this example, initially-set gaming board information, more specifically, an initially-set layout including the gaming board 30 and gaming elements placed on the gaming board 30 is displayed on the display device 4 (based upon the game board information stored in the storage unit 8, at least one portion of a virtual pachinko gaming machine is displayed on the screen of the display device 4). As will be described later, the operator such as a designer (in the case where the simulator 1 is produced as a gaming machine, the player) desirably alters the initially-set layout, that is, more specifically, shifts individual gaming elements and the like, so that a desired layout can be determined (designed)

With respect to another example for displaying gaming board information on the display device 4, for example, a display mode in which, as shown in FIG. 5, the outer shape of a gaming board 30 and a set S of gaming elements are displayed on the screen of the display device 4 in a separate manner is proposed. In this display mode, the operator selects and positions each of the gaming elements on the gaming board 30 one by one from the set S of the gaming elements so that a desired layout is determined.

Referring to FIG. 4, the following description will briefly discuss the gaming elements to be placed on the gaming board 30 in association with an actual pachinko gaming machine. A symbol display unit 104 as a gaming element on which identification symbols (special symbols; normal symbols) are variably displayed so as to determine a gaming state and, effect animations and the like are also displayed, is installed virtually in the center of a gaming area A of the gaming board 30. In an actual pachinko gaming machine, this symbol display unit 104 is an area on which identification symbols are variably displayed and effect animations and the like are also displayed, based upon an image signal input, and the variable display of the identification symbols is started when a gaming ball enters (referred to as “start-entering”) a starting winning opening 115, which will be described later. In the case of an actual pachinko gaming machine, when the variable display of the identification symbols is stopped with a predetermined display mode, a “big-hit” state is generated so that the sequence proceeds to “a special gaming state” (big-hit gaming state) that is advantageous to the player.

A center ornament 103 as a gaming element is placed right above the symbol display unit 104. A starting winning opening 115 and a normal electric accessory 112 as gaming elements are placed below the symbol display unit 104. Here, in an actual pachinko gaming machine, the normal electric accessory 112 is provided with movable members 112a (a so-called “tulip”) capable of shifting to a first state that allows gaming balls to easily enter the starting winning opening 115 as well as to a second state that makes gaming balls difficult to enter the starting winning opening 115, and even in the case of the second state having the closed movable members 112a, only about one gaming ball is allowed to enter. When a gaming ball enters the starting winning opening 115, for example, five prize balls are discharged. As will be described later, in the simulator 1 of the first embodiment, gaming balls are not actually launched, and since only the orbit of the gaming ball is simulated, no prize balls are discharged even upon receipt of a gaming ball in the starting winning opening 115 or the like; instead, a predetermined number of points are added in accordance with the winning mode (in other words, a processing program of the simulator 1 of the first embodiment includes a step of adding a predetermined number of points in accordance with the winning mode). Moreover, as will be described later, the winning in the simulator 1 of the first embodiment is achieved when a virtual gaming ball that traces along a predetermined orbit on the gaming board 30 is made in association with a predetermined gaming element (gaming element for winning) (more specifically, by a process in which the orbit of the gaming ball passes through a gaming element for winning or the winning opening thereof) (in other words, the processing program of the simulator 1 of the first embodiment has a step of defining the winning by making a gaming ball that follows a predetermined orbit on the gaming board associated with a predetermined gaming element).

Normal symbol operating gates 105 and 120 as gaming elements are placed on the right and left sides of the symbol display unit 104. In an actual pachinko gaming machine, when a gaming ball has passed through the symbol operating gate 105 or 120, images “◯ and ×” for use in normal symbol display are alternately flickered on the symbol display unit 104, and when, after a lapse of a predetermined period of time, only the image “◯” is lighted on, the normal electric accessory 112 is shifted to the first state.

A special winning opening 114 as a gaming element, which comprises variable winning device of a door-open/close type that can be converted to “an open state” that is advantageous to the player or to “a closed state” that is disadvantageous to the player, is placed below the normal electric accessories 112. In an actual pachinko gaming machine, this special winning opening 114 is maintained in the opened state for a predetermined period of time, when the variable display of special symbols is stopped in a big-hit stopped mode on the symbol display unit 104. The first embodiment has a configuration in which, for example, each of virtual gaming balls enters the special winning opening 114, a predetermined number of points are added. The aforementioned “special gaming state” refers to a gaming state having the opened state of the special winning opening 114. In the special gaming state, a game in which ten balls are allowed to enter the special winning opening 114 or the opened state continues until 30 seconds have elapsed (hereinafter, referred to as “big-hit game”) is available, and this game can be carried out repeatedly 15 times (rounds).

Side lamps 110 and 116 as gaming elements are placed on the right and left sides of the special winning opening 114. Moreover, an out opening 113 as a gaming element for collecting out balls is placed below the special winning opening 114. A set of rails 122 as gaming elements are placed on the right and left sides of the gaming board 30. As will be described later, the orbit of a virtual gaming ball is raised to move along the rails 122 so that the gaming ball is launched onto the gaming area.

Left wind mills 119, 121 and right wind mills 102, 106 as gaming elements are placed on the upper and lower portions on the right and left sides of the symbol display unit 104. In an actual pachinko gaming machine, these wind mills 102, 106, 119 and 121 are used for changing flow-down paths of gaming balls, and also rotate upon collision with the gaming balls to enhance gaming properties; therefore, in the first embodiment also, these functions are added to orbit calculations of the gaming balls, which will be described later.

Moreover, normal winning openings 108, 109, 117 and 118 as gaming elements are placed on the right and left sides of the starting winning opening 115. In a gaming area A, a number of gaming nails 109 as gaming elements are placed in a scattered manner.

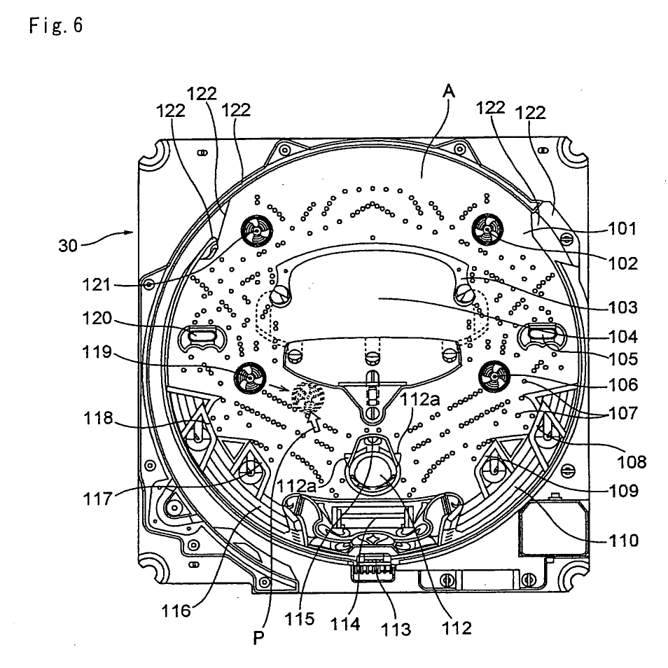

The following description will again discuss controlling processes in accordance with the flowchart of FIG. 2, and in step S1, after initially-set gaming board information has been displayed on the screen of the display device 4, as described above, an editing process of the gaming board information is then carried out in step S2. Specifically, by utilizing functions of the program capable of setting and altering the gaming board information and the parameters., the gaming elements are shifted, enlarged/reduced and rotated, or the parameters are set or altered. More specifically, for example, in the case where the input device 2 is a mouse, a desired gaming element to be shifted is specified by a pointer P on the screen of the display device 4, and the corresponding gaming element is shifted to a predetermined position by using drag and drop operations in which left clicks of the mouse are utilized. FIG. 6 shows one mode of such shifting operations. Moreover, for example, a gaming element can be enlarged/reduced by using a process “left click+CTRL key” or a gaming element can be rotated by using a process “left click+SHIFT key”. Of course, in the case where the input device 4 is a keyboard, a gaming element may be shifted, enlarged/reduced and rotated by directly inputting coordinates through operations in the keyboard.

Here, with respect to these processes capable of setting/altering the game board information (altering steps capable of altering the game board information), in addition to the above-mentioned positional setting and altering of the gaming element, the setting and altering processes of the shape of the front face portion of the gaming board 30 and the setting and altering processes of the size and shape of each of the gaming elements are included.

Here, in the case where parameters that give influences to the orbit of a gaming ball on the gaming board 30 are set or altered, that is, in the case where a step that allows the parameters to be set and altered is carried out (in the same manner as the case in which the setting and altering processes of the shape of the front face portion of the gaming board 30 and the setting and altering processes of the size and shape of each of the gaming elements are carried out), for example, a popup menu is generated on the screen of the display device 4 by right-clicking the mouse, and “parameter setting” is selected from this popup menu so that a numeric value and the like may be inputted through the keyboard. With respect to the parameters, gravitational acceleration (9.8 m/s²), the tilt of the nail 107, parameters for changing the speed of a gaming ball, materials of the gaming board 30 and the gaming elements, the temperature, humidity of the gaming environment and the like can be used. Moreover, with respect to the parameters for changing the speed of a gaming ball, the tilt angle of the gaming board (board face) 30 and the initial velocity upon launching a gaming ball (launching speed of the gaming ball) are included. Moreover, the parameters (material parameters) relating to materials of the gaming board 30 and each of the gaming elements include the coefficient of friction or the coefficient of restitution between the gaming ball and each of various gaming elements.

FIG. 9 shows the coefficient of friction and the coefficient of restitution between the gaming ball (ball) and each of the gaming elements at the time of initial setting. In the first embodiment, the operator allows a table, for example, shown in FIG. 9 to be generated on the screen from the popup menu so that respective numeric values on this table can be set/altered by using the keyboard. In other words, in the first embodiment, processes of the material parameter setting step in which the parameters relating to materials of the gaming board 30 and each of gaming elements and processes of the parameter altering step capable of altering the parameters relating to the materials can be carried out by using the mouse or the like. Moreover, in the first embodiment, in order to positively make these material parameters (numeric values) reflect to orbital calculations, calculating processes, which will be described later, are not carried out unless the material parameters have been set. Of course, this configuration is not necessarily required.

The gaming board information and parameters that have been set/altered by the input device 4 as described above are processed by the gaming board information alteration unit 16 and the parameter alteration unit 18 of the main control unit 6, and then stored in the storage unit 8 (in the case of the above-mentioned application, an operation in which the operator saves the setting/altering information in a file may be prepared) so that these are utilized in calculating processes (step S3) that follow the gaming board editing process in step S2.

FIG. 3 shows a basic sequence of the calculating processes. As shown in this figure, in the calculating processes, first, in step S10, it is determined whether or not the start button has been turned on. The start button may be, for example, a predetermined key on the keyboard constituting the input device 4. In the case of “YES” in this determination, the sequence proceeds to step S11, while in the case of “NO”, the calculating processes are completed.

In step S11, the first gaming ball is set so as to be launched onto the gaming area A (n←1). More specifically, in order to make each of the orbits (each of the orbits of 1st to n-th balls) of gaming balls dispersed on the gaming board 30 by randomly changing the initial velocity of each of the launched balls (launching velocity of the gaming ball) for each of the launching processes, with the gaming board information and parameters (the gravitational acceleration (9.8 m/s²), the coefficient of restitution, the coefficient of friction, the tilt of the gaming board, the tilt of the nail 107 and the like) being fixed, the initial velocity of a gaming ball to be launched is set to a predetermined value within a predetermined variable width centered on the initial velocity of the gaming ball that has been set/altered in step S2.

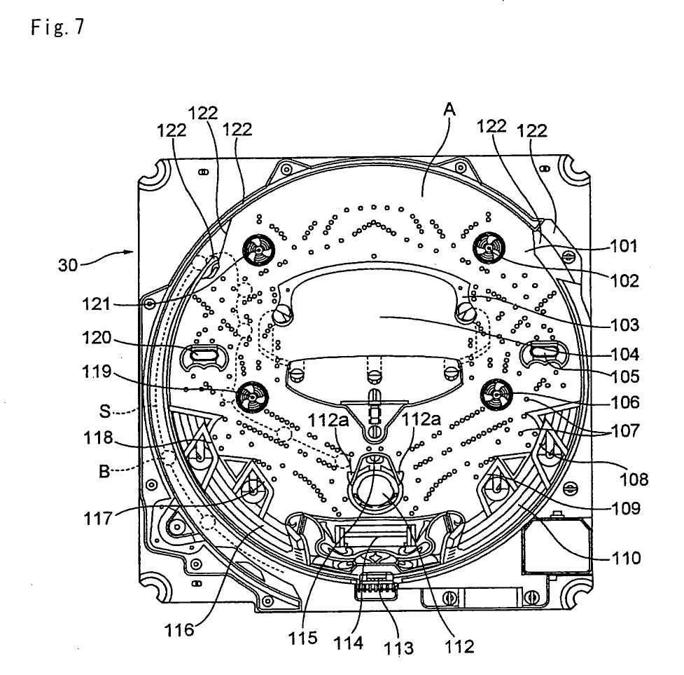

Next, in step S12, the orbit of the first (n=1) launched gaming ball on the gaming board 30 is calculated based upon the gaming board information and parameters that have been set/altered in step S2 (the ball orbit simulation of the first ball (n=1) to be launched is carried out (orbit calculating step)), and in step S13, the calculated orbit of the gaming ball is displayed on the gaming board 30 (the first gaming ball (n=1) is launched (the second displaying step)). Here, these processes are carried out in accordance with a predetermined program on the ball orbit calculation unit 12 of the main control unit 6 and the ball orbit display controlling unit 22 of the display control unit 10. FIG. 7 shows one example of the orbit display of the gaming ball.

Upon completion of the orbit display of the gaming ball in step S13, statistical value calculating processes are successively carried out (step S14 (statistical value calculating step)). In this process, as described above, while the parameters that give influences to the orbit of each gaming ball on the gaming board 30 (in the above-mentioned example, the initial velocity of the launched ball) is being changed, processes in step S12 and step S13 are repeated along a loop processing path L including steps 15 to S17, which will be described later, (by changing n from 1 to a predetermined number (a predetermined number n of virtual gaming balls are launched) so that a predetermined statistical value relating to the gaming result (in the first embodiment, a winning rate or a ball generating rate described later) is calculated; therefore, in the case of the first launched ball, only the data relating to the result of games is stored, and actual statistical value calculating processes are not executed. In other words, the statistical value calculating processes in step S14 are actually carried out, at least, from the second (n=2) launched gaming ball and thereafter.

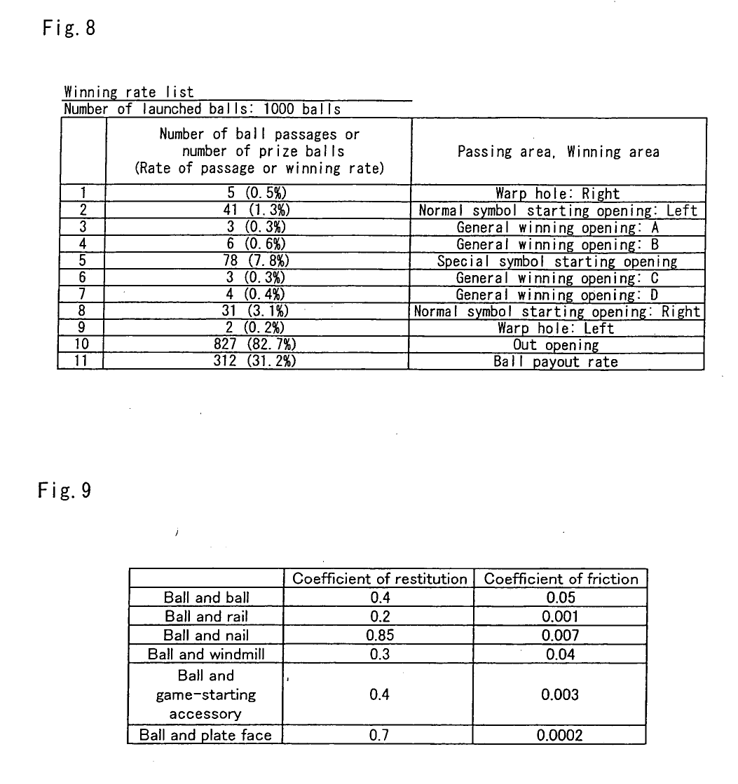

Referring to FIG. 8, the following description will briefly discuss the calculating method of the statistical value. FIG. 8 shows one example of a winning rate list (statistical results) derived from simulating processes in which 1000 gaming balls were launched (that is, n is changed from 1 to 1000 in the above-mentioned loop process). This winning rate list indicates each of predetermined gaming elements and the number of gaming balls that have passed through or entered each of the gaming elements in the simulating processes. These are of course stored in the storage unit 8 as statistical data.

In this winning rate list, supposing that the gaming element for winning, which relates to the addition of points, is only the starting winning opening 115, the ball payout rate as a statistical value (ratio of the number of accumulated points to the number of launched gaming balls onto the gaming board) is calculated to 31.2% on the following equation.
Number of prize balls=(value of added points upon entering the starting winning opening)×(number of balls entered the starting winning opening)=4×78=312
Ball payout rate=number of prize balls/number of launched balls=312/1000=31.2(%)

Here, the winning rate with respect to each of the gaming elements (ratio of the number of entered balls to the number of launched gaming balls onto the gaming board) is calculated on the following equation (the winning rate in each of the gaming elements is shown by a figure in parentheses within the item “number of passed balls or number of entered balls” in the winning rate list of FIG. 8).
Winning rate=number of entered balls/number of launched gaming balls

Thus, the above-mentioned calculating processes are carried out in accordance with a predetermined program on the statistical value calculation unit 14 of the main control unit 6, and the calculated statistical value is displayed on the screen of the display device 4 in accordance with a predetermined program on the statistical value display control unit 24 of the main control unit 6 (for example, symbol display unit 104 of a virtual gaming board image (see FIG. 4)) (step S15 (third displaying step)).

Upon completion of processes in step S15, next, in step S16, the second gaming ball is set so as to be launched onto the gaming area A (n←n+1). In this case also, in the same manner as step S11, the initial velocity of a gaming ball to be launched is set to a predetermined value within a predetermined variable width centered on the initial velocity of the gaming ball that has been set/altered in step S2. Then, in step S17, it is determined whether or not a stop button is pressed ON. This stop button may also be, for example, a predetermined key of the keyboard constituting the input device 4. In the case of “YES” in this determination, the sequence proceeds to step S18, and the launching process onto the gaming area A is stopped (n is set to 0), thereby completing the calculating processes. In contrast, in the case of “NO”, the sequence returns to step S12 so that the aforementioned processes of step S12 to step S16 are repeatedly carried out on the second gaming ball.

As described above, in the pachinko machine simulator 1 of the first embodiment, since parameters relating to the materials for the gaming board and each of the gaming elements are used upon calculating the orbit of a gaming ball on the gaming board, ball orbit calculations that are remarkably similar to those of an actual pachinko gaming machine can be carried out. Moreover, since the parameters relating to the materials include the coefficient of friction and coefficient of restitution between the gaming ball and each of the gaming elements, physical values that are directly related to the materials for the gaming board and each of the gaming elements are incorporated into the orbital calculations so that ball orbits that are remarkably similar to those of an actual pachinko gaming machine can be effectively calculated in an efficient manner.

Moreover, in the pachinko machine simulator 1 of the first embodiment, since the parameters relating to the materials for the gaming board and each of the gaming elements can be altered, the convenience of a change of design is improved. Moreover, in the pachinko machine simulator of the first embodiment, the gaming board information includes the launching velocity of the gaming ball, the tilt angle of the gaming board, and any one of the shape, position and size of each of the gaming elements. In other words, parameters that give influences to the orbit of the gaming ball on the gaming board are included therein as the gaming board information. For this reason, operations that are remarkably similar to the operations of an actual gaming ball can be simulated so that the reliability of an orbital calculation of a gaming ball can be further improved. Moreover, pieces of information that are indispensable for designing a gaming board are incorporated as the gaming board information, which can be helpful to the design of a gaming board.

Moreover, the pachinko machine simulator 1 of the first embodiment makes it possible to determine a final layout or the like of gaming elements on the gaming board 30 based upon an orbit of a gaming ball and statistical values displayed on the screen of the display device 4 of the simulator main body 3 using a computer, to allow even a beginner to easily design a pachinko gaming machine, and consequently to reduce the number of processes upon forming a prototype of the gaming machine. In the pachinko machine simulator 1 of the first embodiment, since parameters that give influences to the orbit of a gaming ball on the gaming board can be set/altered, it is possible to enhance the reliability of orbital calculations and calculations of statistical values of a gaming ball. Moreover, in the pachinko machine simulator 1 of the first embodiment, since the parameters that give influences to the orbit of a gaming ball on the gaming board include a launching velocity of a gaming ball, it becomes possible to reproduce an operation remarkably similar to the actual operation of a gaming ball, and consequently to further improve the reliability of orbital calculations and calculations of statistical values of a gaming ball.

Moreover, in the pachinko machine simulator 1 of the first embodiment, since the launching velocity of each of gaming balls is randomly varied, it becomes possible to make the orbits of the gaming balls dispersed, and consequently to reproduce an operation remarkably similar to the actual operation of a gaming ball. Therefore, it becomes possible to further improve the reliability of orbital calculations and calculations of statistical values. Moreover, in the pachinko machine simulator 1 of the first embodiment, since information that is indispensable for designing processes of a gaming machine is incorporated as gaming board information, it is possible to easily design a gaming board. Moreover, in the pachinko machine simulator 1 of the first embodiment, since information for changing the velocity of a gaming ball is incorporated as gaming board information, the many-sided designing processes of a gaming board can be carried out in association with the velocity of a gaming ball.

In the pachinko machine simulator 1 of the first embodiment, the information for changing a velocity of a gaming ball includes the launching velocity of a gaming ball and the tilt angle of the gaming board. For this reason, more specific designing processes related to the velocity of a gaming ball can be carried out. Moreover, in the pachinko machine simulator 1 of the first embodiment, since the ratio of the number of entered balls to the number of launched gaming balls onto the gaming board is calculated as a statistical value, the layout of a gaming board can be made based upon the so-called “winning rate”, and the designing of a gaming board with a predetermined winning rate can be easily carried out. Furthermore, in the pachinko machine simulator 1 of the first embodiment, since the ratio of the number of accumulated points to the number of launched gaming balls onto the gaming board is calculated as a statistical value, the layout of a gaming board can be made based upon the so-called “ball payout rate”, and the designing of a gaming board with a predetermined ball payout rate can be easily carried out.

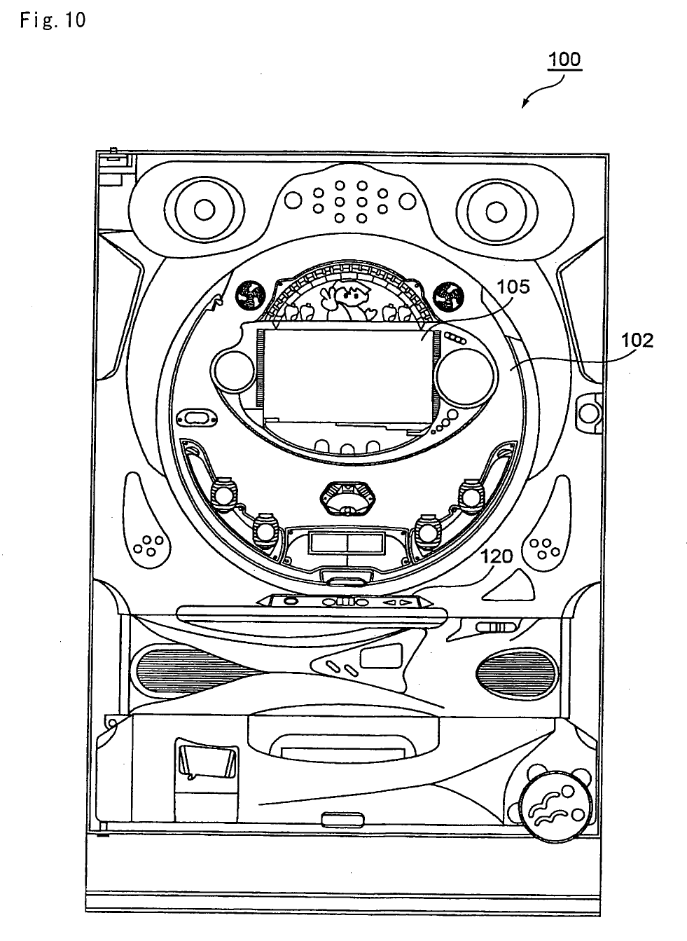

Here, the above-mentioned functions of the simulator 1 may be prepared in an actual pachinko gaming machine. In other words, an actual pachinko gaming machine 100, which is shown in FIG. 10, may have the structure or functions of the simulator main body 3 shown in FIG. 1, and the display unit 105 on the gaming board 102 of the pachinko gaming machine 100 may also have functions of the display device 4 in FIG. 1, and switches 120 on the operation panel of the pachinko gaming machine 100 may also have functions of the input device 2 of FIG. 1.

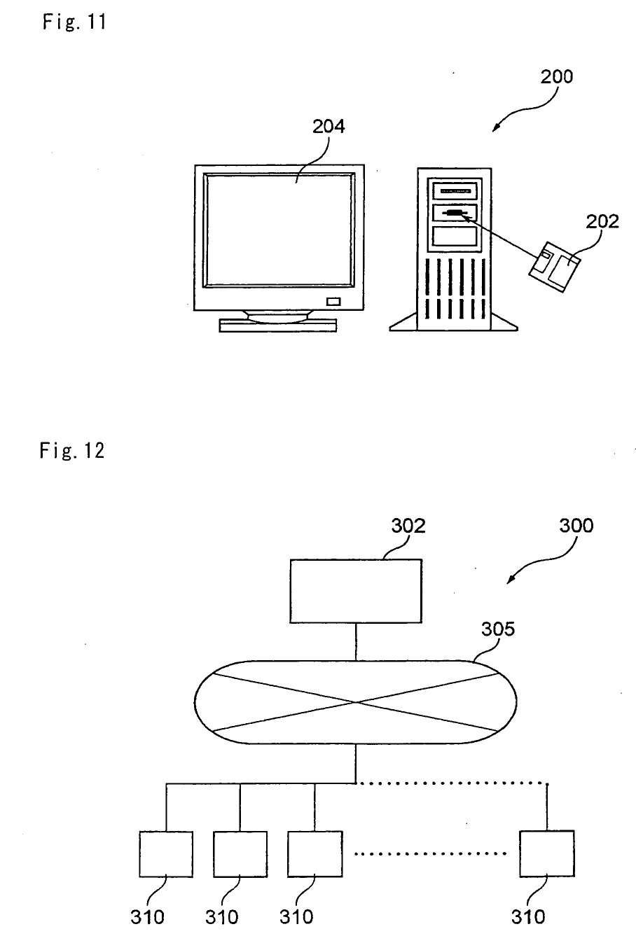

Moreover, the above-mentioned processes of the simulator 1 may be stored in a storage medium, such as a floppy disk (registered trademark) and a CD, as a program. In this case, as shown in FIG. 11, for example, data on the storage medium 202 may be read by, for example, a personal computer 200, and the program is executed so that the aforementioned simulation image is displayed on the screen of the display 204 of the computer 200.

Moreover, the above-mentioned simulation may also be realized on a game network system. FIG. 12 shows one embodiment of such a system. A game network system 300 shown in FIG. 12 is provided with a server 302 that carries out controlling processes on the pachinko game and a plurality of gaming terminals 310 that are connected to a server 302 via a network 305. The server 302 has the aforementioned structure and functions of the simulator main body 3 shown in FIG. 1, and each of the gaming terminals 310 has the structure or functions of the input device 2 and the display device 4 of FIG. 1. In this structure, the player who operates the corresponding terminal 310 transmits and receives data to and from the server 302 via the network 305 so that the aforementioned simulation can be realized. Moreover, another mode in which the player downloads the above-mentioned simulation program data from the server 302 to his or her own terminal (hard disk drive or the like) so that the aforementioned simulation can be realized individually may be proposed.

### Second Embodiment

The following description will discuss an embodiment of a gaming machine in accordance with the second aspect of the present invention. The gaming machine relating to the second embodiment has the same structure as that of the gaming machine in accordance with the first embodiment, except for the following points. Therefore, in the second embodiment, those constituent elements corresponding to the constituent elements of the gaming machine of the first embodiment are indicated by the same reference numerals, and explained.

With respect to the structure of the pachinko machine simulator relating to the second embodiment, the same structure as that of the first embodiment is used, and since it has been explained by reference to FIG. 1, only the points different from the first embodiment will be explained.

As shown in FIG. 1, a simulator 1 mainly comprises a simulator main body 3 that constitutes a computer, an input device 2 as operation means that allows operations and a display device 4 as display means with which an image is displayed.

The simulator main body 3 comprises a main control unit 6 that controls various operations of the simulator 1, a storage unit 8 as storage means, which stores parts information relating to the parts constituting a pachinko gaming machine as a gaming machine, more specifically, gaming board information relating to a gaming board of the pachinko gaming machine having a predetermined gaming area and gaming elements (nails, windmills, game-starting accessories and the like) that are placed on the gaming board, and a display control unit 10 as display control means that carries out a display control on the display device 4 based upon a control signal given from the main control unit 6.

Moreover, the input device 2 comprises a keyboard, a mouse or other optional switches (including a controller as used for various domestic gaming machine) is connected to the main control unit 6, and used for inputting signals that set or alter parameters that give influences to the gaming board to the main control unit 6. In other words, the input device 2 functions as setting means for setting/altering parts information (gaming board information and parameters).

Moreover, the display device 4, which comprises various conventionally-known display devices such as liquid crystal devices and CRT devices, can display at least one portion of a virtual pachinko gaming machine (simulated gaming machine) based upon the above-mentioned gaming board information. The main control unit 6 is provided with a ball orbit calculation unit (computation means) 12 that calculates orbits on the gaming board of gaming balls to be launched onto the gaming board based upon the gaming board information stored in the storage unit 8. In fact, based upon the gaming board information and the member information that has been altered by the alteration units 16 and 18, the ball orbit calculation unit 12 calculates the orbit of simulated gaming media corresponding to gaming balls flowing down on the pachinko gaming machine (simulated gaming machine) displayed in the virtual space on the display device 4. And the display control unit 10 is provided with a ball orbit display control unit (simulation means) 22 for simulating the orbits of gaming balls calculated by the ball orbit calculation unit 12 on the display device 4. More specifically, based upon the orbit calculated by the ball orbit calculation unit 12, the ball orbit display controlling unit 22 displays a simulation image in which virtual gaming balls (simulated gaming media) flow down on a virtual pachinko gaming machine (simulated gaming machine) on the display device 4. The main control unit 6 is provided with a statistical value calculation unit 14 that calculates predetermined statistical values relating to the results of games (the results caused by the simulated gaming media onto the simulated gaming machine) by repeating the orbit calculations and the simulating processes with parameters that give influences to the orbits of gaming balls on the gaming board being changed.

Here, the display control unit 10 also functions as arrangement means that arranges and displays a virtual pachinko gaming machine (simulated gaming machine) based upon the member information (gaming board information and parameters) that has been altered by each of the alteration units 16 and 18 and the gaming board information stored in the storage unit 8 (more specifically, data relating to the simulated gaming machine is expanded on the working area of the RAM or the like based upon the member information).

With respect to the designing process of a pachinko gaming machine by the simulator in accordance with the second embodiment, the same processes as those of the first embodiment are carried out, and since those processes have been already explained by reference to FIGS. 2 and 3, the following explanation will discuss only the points different from the first embodiment.

In step S1 of FIG. 2, the process of displaying game board information on the screen of the display device 4 functions as an arranging step. FIG. 4 shows one example in which the game board information is displayed on the display device 4. In this example, initially-set gaming board information, more specifically, an initially-set layout including the gaming board 30 and gaming elements placed on the gaming board 30 is displayed on the display device 4 (at least one portion of a virtual pachinko gaming machine is arranged and displayed on the screen (virtual space) of the display device 4 based upon the gaming board information stored in the storage unit 8)

In step S1, after initially-set gaming board information has been displayed on the screen of the display device 4, an editing process of the gaming board information is then carried out in step S2. Specifically, by utilizing functions of the program capable of setting and altering the gaming board information and the parameters, the gaming elements are shifted, enlarged/reduced and rotated, or the parameters are set or altered. Here, in addition to the above-mentioned setting/altering processes of the layout position of individual gaming elements (for each member), these processes (member information setting step) that allow the setting/altering of the gaming board information include setting/altering processes of the shape of the front face portion of the gaming board 30 and setting/altering processes of individual forms (the size, shape and the like) of the gaming elements.

Here, in the case where parameters that give influences to the orbit of a gaming ball on the gaming board 30 are set or altered, that is, in the case where a step that allows the parameters to be set and altered (member information setting step) is carried out (in the same manner as the case in which the setting and altering processes of the shape of the front face portion of the gaming board 30 and the setting and altering processes of the size and shape of each of the gaming elements are carried out), for example, a popup menu is generated on the screen of the display device 4 by right-clicking the mouse, and “parameter setting” is selected from this popup menu so that a numeric value and the like may be inputted through the keyboard. With respect to the parameters, gravitational acceleration (9.8 m/s²), the tilt of the nail 107, parameters for changing the speed of a gaming ball, materials of the gaming board 30 and the gaming elements, the temperature and humidity of the gaming environment and the like can be used. Moreover, the above-mentioned parameters also include information related to the gaming ball (the simulated gaming media), for example, a parameter and the like for changing the velocity of a gaming ball. In other words, the processing program of the simulator 1 of the second embodiment includes a gaming medium information setting step that sets information related to the simulated gaming medium.

FIG. 9 shows the coefficient of friction and the coefficient of restitution between the gaming ball (ball) and each of the gaming elements at the time of initial setting. In the second embodiment, the operator allows a table, for example, shown in FIG. 9 to be generated on the screen from the popup menu so that respective numeric values on this table can be set/altered by using the keyboard. In other words, in the second embodiment, the operator is allowed to set/alter numeric information relating to repulsion and frictional force (material parameters) for each of the members (gaming board 30, gaming elements and the like).

FIG. 3 shows a basic sequence of the calculating processes.

The ball orbit simulation to be carried out in step S12 functions as an orbit calculating step.

The process to be carried out in step S13 in which the orbit of a gaming ball is displayed on the gaming board 30 functions as a displaying step.

The statistical value calculating process to be carried out in step S14 functions as an accumulating process.

Referring to FIG. 8, the following description will briefly discuss the calculating method of the statistical value. FIG. 8 shows one example of a winning rate list (statistical results) derived from simulating processes in which 1000 gaming balls were launched (that is, n is changed from 1 to 1000 in the above-mentioned loop process). This winning rate list indicates each of predetermined gaming elements and the number of gaming balls that have passed through or entered each of the gaming elements in the simulating processes. These are of course stored in the storage unit 8 as statistical data.

In this winning rate list, supposing that the gaming element for winning, which relates to the addition of points, is limited only to the starting winning opening 115 (special symbol starting opening), the ball payout rate as a statistical value (ratio of the number of accumulated points to the total number (the number of launched gaming balls) of the gaming balls (simulated gaming media) that flow down on the gaming board) is calculated to 31.2% on the following equation:
Number of prize balls=(value of added points upon entering the starting winning opening)×(number of balls entered the starting winning opening)=4×78=312
Ball payout rate=number of prize balls/number of launched balls=312/1000=31.2(%)

Here, the winning rate with respect to each of the gaming elements (ratio of the number of balls determined as entered balls to the total number (the number of launching operations) of gaming balls (simulated gaming media) flowing down on the gaming board) is calculated from the following equation (the winning rate in each of the gaming elements is shown by a figure in parentheses within the item “number of passed balls or number of entered balls” in the winning rate of FIG. 8).

The process in step S15 and in which the statistical value calculated is displayed on the screen of the display device 4 functions as an accumulated result displaying step.

The gaming elements placed on the gaming board 30 of the second embodiment are the same as those of the first embodiment, and since these have been explained by reference to FIGS. 4 to 7, the following description will discuss only the points different from the first embodiment.

The processing program of the simulator 1 includes an accumulating step in which a predetermined number of points are added depending on winning modes. The winning in the simulator 1 is achieved when a virtual gaming ball (simulated gaming medium) that traces along a predetermined orbit on the gaming board 30 is made in association with a predetermined gaming element (gaming elements for winning: winning determining area). In other words, the processing program of the simulator 1 of the second embodiment includes a step in which the winning state is achieved when a virtual gaming ball that traces along a predetermined orbit on the gaming board is made in association with a predetermined gaming element so that the winning state is achieved, that is, more specifically, a winning determining step in which, when a simulated gaming medium has passed through a predetermined winning determining area on the gaming board, it is determined that the winning is achieved. Moreover, the processing program of the simulator 1 of the second embodiment also includes a point setting step in which points are set for each of the winning determining areas. Furthermore, the processing program of the simulator 1 also includes a gaming medium information setting step in which information relating to the simulated gaming medium is set.

In the above explanation, simulation processes of gaming balls on the gaming board 30 have been discussed; however, actually, gaming balls on the pachinko gaming machine are allowed to flow down through places other than the gaming board 30, and it is indispensable for examining the flowing behavior thereof in designing a pachinko gaming machine. In an actual pachinko gaming machine, when a gaming ball has entered a predetermined winning area on the gaming board 30, gaming balls are paid out to the player as prize balls through a prize ball payout passage from a payout device. In this case, all the paid-out gaming balls have to be discharged onto the upper tray. In other words, upon designing a pachinko gaming machine, it is necessary to prevent gaming balls from being discharged to the lower tray, unless the upper tray is filled with gaming balls. In contrast, it is necessary to discharge one portion of gaming balls on the upper tray to the lower tray when the upper tray is filled with gaming balls.

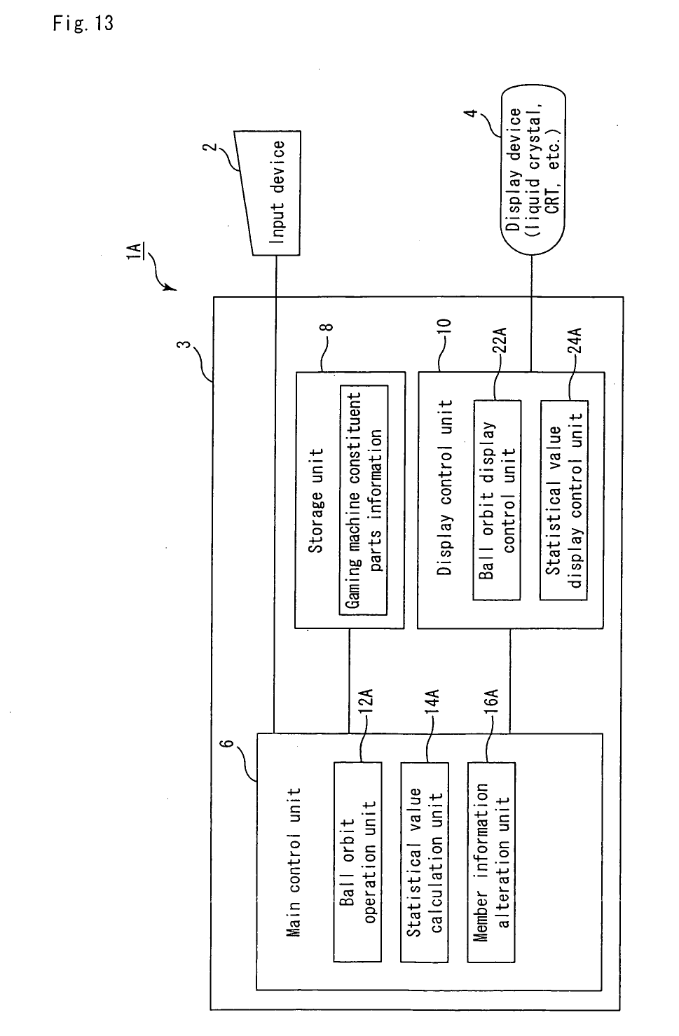

Referring to FIGS. 13 to 17, the description on the above-mentioned pachinko machine simulator in accordance with the second embodiment will be given.

FIG. 13 shows a pachinko machine simulator 1A which allows a designing process of such a system that can examine a payout operation or the like of gaming balls in a pachinko gaming machine. Here, the pachinko machine simulator 1A has a structure similar to that of the aforementioned simulator 1; therefore, those constituent parts that are the same as those of the simulator 1 are indicated by the same reference numerals and the description thereof is omitted. As shown in the figure, the pachinko machine simulator 1A mainly comprises a simulator main body 3, an input device 2 and a display device 4. Of course, the input device 2 and the display device 4 may be separated from the simulator main body 3, or may be integrally formed together with the simulator main body 3.

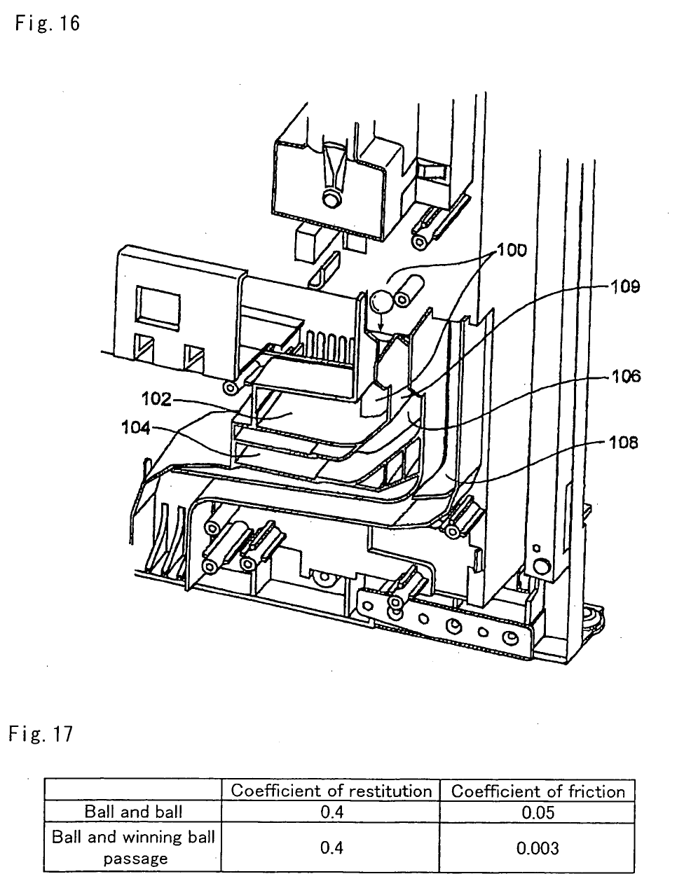

The simulator main body 3 is provided with a main control unit 6 that controls various operations of the simulator 1, a storage unit 8 as storage means which stores member information (gaming machine constituent parts information) relating respective members constituting a pachinko gaming machine as a gaming machine and a display control unit 10 that carries out a display control on the display device 4 based upon a control signal given from the main control unit 6. FIG. 16 mainly shows a payout structure portion for gaming balls that is placed below on the rear side of the gaming board 30, and in this figure, reference numeral 100 indicates a prize ball payout passage for guiding gaming balls from the payout device to an entrance 102 of the upper tray, reference numeral 106 indicates a gaming-ball discharging path, separated from the downstream portion of the prize ball payout passage 100 by a partition wall 109, one end of which communicates with the prize ball payout passage 100 at the edge of the upper end of the partition wall 109, with the other end being connected to an entrance 104 of the lower tray, and reference numeral 108 indicates a ball-drawing passage; thus, the member information, stored in the storage unit 8, includes information of the various kinds of members forming these passages 100, 106, 108 and the like. Here, in FIG. 16, for convenience of explanation, the passages 100, 106 and 108 are illustrated as if these were opened on the rear side; however, actually, the rear faces of the passages 100, 106 and 108 are closed by wall faces, not shown, so that needless to say, gaming balls are prevented from coming off from the passages 100, 106 and 108. Moreover, as is well known, when the upper tray becomes filled with gaming balls, the entrance 102 of the upper tray is set to a closed state. Therefore, when the wining-ball passage 100 becomes a filled state due to paid-out prize balls later, gaming balls overflowing therefrom are allowed to proceed into the gaming-ball discharging passage 108.

The input device 2 is used so as to input a signal for setting or altering the member information to the main control unit 6. In other words, the input device 2 functions as setting means for setting/altering the member information (information for the various members forming the passages 100, 106, 108 and the like). Moreover, the display device 4 can display at least one portion of a virtual pachinko gaming machine (simulated gaming machine) as shown in FIG. 16 based upon the member information. The main control unit 6 is provided with a ball orbit operation unit (orbit calculation means) 12A that calculates orbits of gaming balls that are discharged from the payout device to the entrance 102 of the upper tray through the prize ball payout passage 100 as well as orbits and the like through which, when the upper tray is filled with gaming balls, one portion of gaming balls on the upper tray are discharged onto the lower tray. In fact, based upon the member information and member information that has been altered at an alteration unit 16A, which will be described later, the ball orbit operation unit 12A calculates orbits of gaming balls (simulated gaming media) that flow down in the pachinko gaming machine (simulated gaming machine) displayed on the display device 4 as shown in FIG. 16. Here, the display control unit 10 is provided with a ball-orbit display control unit 22A for simulating the orbits of gaming balls calculated by the ball-orbit operation unit 12A on the display device 4. Moreover, the main control unit 6 is provided with a statistical value operation unit 14A that calculates predetermined statistical values upon designing, by repeating the orbit calculations and the simulating processes with parameters that give influences to the orbits of gaming balls going along, for example, the passages 100, 106 and 108 on the gaming board being changed. Moreover, the display control unit 10 is provided with a statistical value display control unit 24A that allows the display device 4 to display the statistical values calculated by the statistical-value operation unit 14A.

Moreover, the main control unit 6 is provided with a member information alteration unit 16A that alters the member information based upon a signal from the input device 2. Here, the display control unit 10 also functions as arrangement means for arranging and displaying a virtual pachinko gaming machine (simulated gaming machine) based upon the member information stored in the storage unit 8 or the member information altered by the member information alteration unit 16A.

Here, in the second embodiment, the simulator 1A may have the functions of the aforementioned simulator 1 in a combined manner. In other words, the input device 2 may be configured to set/alter the information of various members forming the passages 100, 106 and 108 as well as the gaming board information and the parameters that give influences to the orbit or a gaming ball, the storage unit 8 may be configured to store the information of various members forming the passages 100, 106 and 108 along with the gaming board information and the parameters, and the display device 4 may selectively display the image shown in FIG. 16 and the image shown in FIG. 4. Moreover, the ball-orbit operation unit 12A may also have the functions of the ball-orbit calculating unit 12, and the statistical value operation unit 14A also have the functions of the statistical value calculation unit 14; moreover, the member information alteration unit 16A may also have the functions of the gaming board information alteration unit 16 and the functions of the parameter alteration unit 18, and the display control units 22A and 24A may also have functions of the display control units 22 and 24.

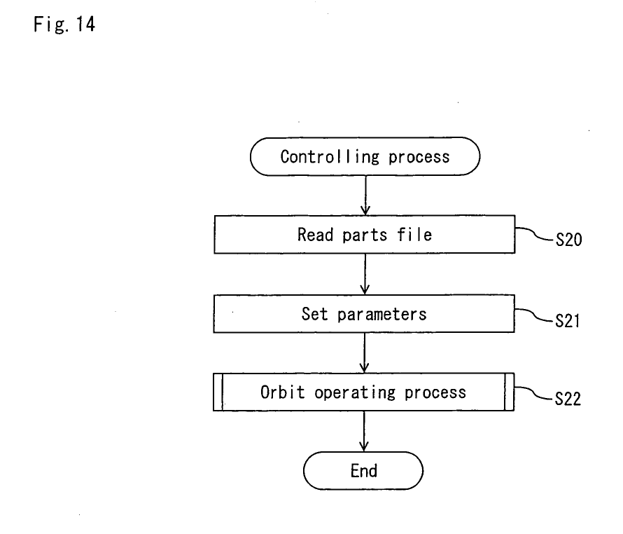

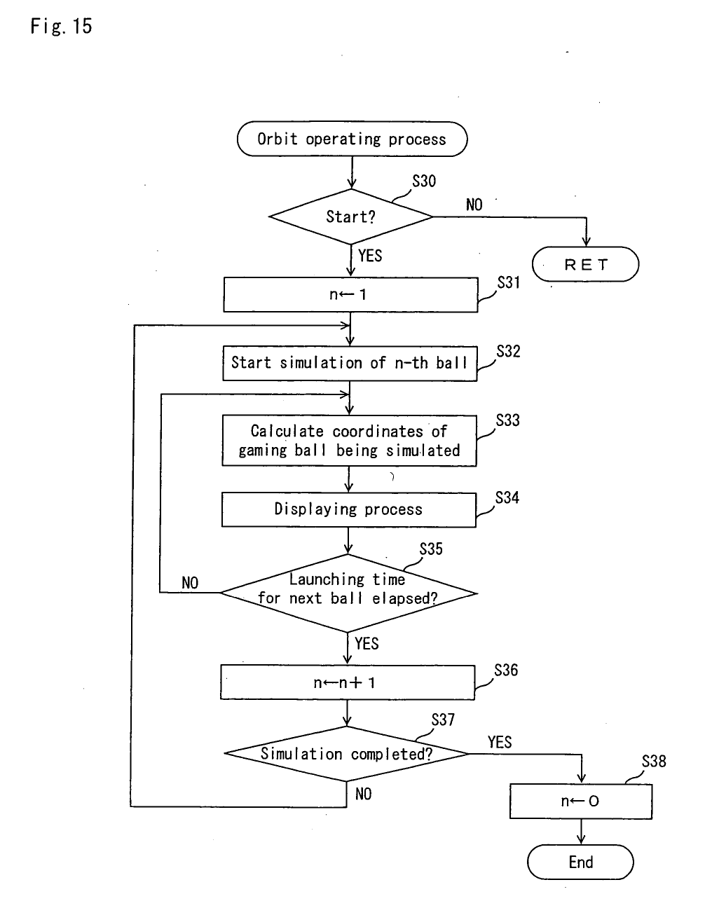

Next, referring mainly to flowcharts of FIGS. 14 and 15, the following description will discuss a designing process of a pachinko gaming machine by using the simulator 1A having the above-mentioned configuration in detail.

As shown in the flowchart of controlling processes of FIG. 14, in step S20, the parts file stored in the storage unit 8 is read so that information of various parts forming the passages 100, 106, 108 and the like is displayed on the screen of the display device 4 (arranging step).

FIG. 16 shows one example of member information displayed on the display device 4. In this example, more specifically, the initially set member information, more specifically, the initial set layout of the gaming machine constituent parts forming the passages 100, 106 and 108 and the like, created by 3DCAD, is displayed on the display device 4. In the same manner as the aforementioned designing of the gaming board, the operator, such as a designer (the player, in the case where the simulator 1 is manufactured as a gaming machine), is allowed to determine (design) a desired layout by desirably altering the initial set layout, more specifically, by shifting the respective gaming machine constituent parts individually.

After displaying the member information as shown in FIG. 16 on the display device 4, a parameter setting process is carried out in step S21. More specifically, by utilizing functions of the program that allows setting/altering of the member information, the gaming machine constituent components forming the passages 100, 106 and 108 and the like are shifted, enlarged/reduced and rotated, or the parameters that give influences to the orbits of gaming balls along the passages 100, 106 and 108 and the like are set/altered. In this case, the operations are carried out in the same manner as the aforementioned gaming board designing process.

With respect to the parameters that give influences to orbits of gaming balls along the passages 100, 106, 108 and the like, gravitational acceleration (9.8 M/s²), materials of the gaming machine constituent components, the temperature and humidity of the gaming environment and the like are listed. Moreover, with respect to the parameters (material parameters) relating to the materials of the gaming machine constituent components, the coefficient of friction or the coefficient of restitution between the gaming ball and each of the passages of 100, 106 and 108 are included.

FIG. 17 shows the coefficient of friction and the coefficient of restitution between the gaming balls as well as between the gaming ball (ball) and the prize ball payout passage 100 at the time of the initial setting. In the second embodiment, the operator allows a table, for example, shown in FIG. 17 to be generated on the screen from the above-mentioned popup menu so that respective numeric values on this table can be set/altered individually by using the keyboard. In other words, in the second embodiment, the operator is allowed to set/alter pieces of numeric value information relating to repulsion and frictional force (material parameters) for each of the members.

The member information and parameters thus set/altered by the input device 4 are processed in the member information alteration unit 16A of the main control unit 6, and then stored in the storage unit 8 so as to be utilized in the orbit operation process (step S22) that follows the parameter setting process in step S21.

FIG. 15 shows a basic sequence of the orbit operation process. As shown in this figure, in this operation process, first, in step S30, it is determined whether or not the start button has been turned on. The start button may be prepared as, for example, a predetermined key on the keyboard that forms the input device 4. In the case of “YES” in this determination, the sequence proceeds to step S31, while in the case of “NO”, the operation process is completed.

In step S31, the first gaming ball to be paid out from the payout device is set (n←1). Next, in step S32, the orbit of the first gaming ball (n=1) along the passages 100, 106 and 108 is calculated based upon the member information and the parameters such as (the gravitational acceleration (9.8 n/s²), the coefficient of restitution, the coefficient of friction, the materials and tilts of the passages 100, 106 and 108 and the like) (that is, the ball-orbit simulation of the first gaming ball (n=1) is carried out (orbit calculating process)). Next, in step S33, coordinates of the gaming ball during the simulation are calculated, and in step S34, the orbit of the gaming ball calculated is displayed on the display device 4 together with the image shown in FIG. 16 (the first gaming ball (n=1) is allowed to flow down (displaying step)). Here, these processes are carried out in accordance with a predetermined program by the ball-orbit operation unit 12A of the main control unit 6 and the ball-orbit display control unit 22A of the display control unit 10.

While displaying the orbit of the gaming ball in step S34, a change over time in the coordinates of the gaming ball in the simulation is monitored, and based upon the monitoring process, in step S35, it is determined whether or not it is the time at which the payout of the second gaming ball is started (that is, whether or not the next-ball launching time has elapsed). In the case of “YES” in this determination, the sequence proceeds to step S36, and in the case of “NO”, the sequence returns to step S33.

In step S36, the second gaming ball to be paid out from the payout device is set (n←n+1). Thereafter, in step S37, it is determined whether or not the simulation process is completed. In the case of “YES” in this determination, the sequence proceeds to step S38, and the payout of the gaming ball from the payout device is stopped (n is set to 0), thereby completing the operation process. In contrast, in the case of “NO”, the sequence returns to step S32, thereby repeating the processes of step S32 to S37 with respect to the second gaming ball.

As described above, in the pachinko machine simulator 1 or 1A of the second embodiment, based upon the information relating to members constituting a pachinko gaming machine, the orbit of a simulated gaming medium (gaming ball) flowing down on a simulated gaming machine (pachinko gaming machine) in a virtual space is calculated, and based upon the calculated orbit, the image in which the simulated gaming medium flows down on the simulated gaming machine is displayed (that is, not only the orbit of a gaming ball on the gaming board 30, but also the orbit of a gaming ball along the passages 100, 106, 108 and the like is displayed); therefore, the orbit of the gaming medium can be recognized at the pre-stage of the actual manufacturing process of a gaming machine. Therefore, it is not necessary to actually manufacture a prototype or the like of the gaming machine and conduct examining processes thereon, thereby making it possible to greatly cut the developing costs of the gaming machine.

Moreover, in the pachinko machine simulator 1 or 1A of the second embodiment, numeric value information relating to the repulsion and frictional force can be set for each of the various members forming a pachinko gaming machine. For this reason, the orbit of the gaming ball can be examined by taking changes in physical properties of the members due to the environmental factors such as humidity and temperature into consideration. Moreover, in accordance with the pachinko machine simulator 1 or 1A of the second embodiment, with respect to various members constituting a pachinko gaming machine, the layout position thereof can be set for each of the members. For this reason, the orbit of the gaming machine can be examined with the layout position of each of the members being changed; thus, it becomes possible to improve the reliability of the orbit calculations of the gaming ball. Moreover, since such information indispensable for the designing of a gaming machine, that is, “the layout position of each of the members”, is incorporated, the designing of a gaming machine can be desirably carried out easily.

Moreover, the pachinko machine simulator 1 or 1A of the second embodiment makes it possible to determine the form (shape, size and the like) of each of the members constituting a pachinko gaming machine individually. For this reason, the orbit of the gaming ball can be examined, with the form of each of the members being changed, so that it becomes possible to improve the reliability of orbit calculations of the gaming ball. Moreover, in the pachinko machine simulator 1 or 1A of the second embodiment, since information relating to the gaming ball can be set, it becomes possible to carry out the designing process by taking into consideration, for example, changes in physical properties due to the material of the gaming ball and the environment, and the flowing speed of the gaming ball. Therefore, operations remarkably similar to the actual operations of the gaming ball can be reproduced so that it becomes possible to further improve the reliability of the orbit calculations of the gaming ball. Moreover, in the pachinko machine simulator 1 or 1A of the second embodiment, predetermined statistical values (statistical values and the like concerning the results caused by the gaming ball to the gaming machine) are accumulated, and the results of the accumulation are displayed; therefore, it is possible to determine the final layout and the like of each of the members based upon the orbit of the gaming ball and the statistical values thus displayed. For this reason, this configuration allows even a beginner to easily design a pachinko gaming machine, and consequently to reduce the number of processes upon forming prototypes of the gaming machine. Moreover, the statistical values allow the designer to confirm the trend of influences given by the gaming ball to the gaming machine, and consequently to further improve the developing efficiency of a gaming machine. In particular, in the pachinko machine simulator 1, since the ratio of the number of entered balls to the number of launched gaming balls onto the gaming board is calculated as a statistical value, the layout of a gaming board can be made based upon the so-called “winning rate”, and the designing of a gaming board with a predetermined winning rate can be easily carried out. Furthermore, in the pachinko machine simulator 1 of the second embodiment, since the ratio of the number of accumulated points to the number of launched gaming balls onto the gaming board is calculated as a statistical value, the layout of a gaming board can be made based upon the so-called “ball payout rate”, and the designing of a gaming board with a predetermined ball payout rate can be easily carried out. In particular, in the pachinko machine simulator 1, since parameters that give influences to the orbit of a gaming ball on the gaming board can be set/altered, it is possible to enhance the reliability of orbital calculations and calculations of statistical values of a gaming ball. Moreover, in the pachinko machine simulator 1 of the second embodiment, since the parameters that give influences to the orbit of a gaming ball on the gaming board include a launching velocity of a gaming ball, it becomes possible to reproduce an operation remarkably similar to the actual operation of a gaming ball, and consequently to further improve the reliability of orbital calculations and calculations of statistical values of a gaming ball.

In the pachinko machine simulator 1, since the launching velocity of each of gaming balls is randomly varied, it becomes possible to make the orbits of the gaming balls dispersed, and consequently to reproduce a state remarkably similar to the actual state of a gaming ball. Therefore, it becomes possible to further improve the reliability of orbital calculations and calculations of statistical values of a gaming ball. In particular, in the pachinko machine simulator 1, since information for changing the velocity of a gaming ball is incorporated as gaming board information, the many-sided designing processes of a gaming board can be carried out in association with the velocity of a gaming ball.

In the pachinko machine simulator 1, the information for changing the velocity of a gaming ball includes the launching velocity of a gaming ball and the tilt angle of the gaming board. For this reason, more specific designing processes related to the velocity of a gaming ball can be carried out.

Here, the above-mentioned functions of the simulator 1 or 1A may be prepared in an actual pachinko gaming machine. In other words, an actual pachinko gaming machine 100, which is shown in FIG. 10, may have the structure or functions of the simulator main body 3 shown in FIG. 1 or FIG. 13, and the display unit 105 on the gaming board 102 of the pachinko gaming machine 100 may also have functions of the display device 4 in FIG. 1 or FIG. 13, and switches 120 on the operation panel of the pachinko gaming machine 100 may also have functions of the input device 2 of FIG. 1.

Moreover, the above-mentioned processes of the simulator 1 or 1A may be stored in a storage medium, such as a floppy disk and a CD, as a program.

Moreover, the above-mentioned simulation may also be realized on a game network system. FIG. 12 shows one embodiment of such a system. A game network system 300 shown in FIG. 12 is provided with a server 302 that carries out controlling processes on the pachinko game and a plurality of gaming terminals 310 that are connected to a server 302 via a network 305. The server 300 has the aforementioned structure and functions of the simulator main body 3 shown in FIG. 1 or FIG. 13, and each of the gaming terminals 310 has the structure or functions of the input device 2 and the display device 4 of FIG. 1 or FIG. 13.

The second embodiment is configured to examine the behavior (orbit) of the gaming ball during flowing down on the gaming machine; however, a gaming medium other than the gaming ball, for example, a medal, may be examined in its orbit. Moreover, the above-mentioned embodiments are configured to alter the coefficient of friction and coefficient of restitution; however, these factors may be made unalterable. In the above-mentioned embodiments, the second aspect of the present invention is applied to the simulation of a pachinko gaming machine; however, it is needless to say that the second aspect of the present invention may be applied to the simulation of another gaming machine (game machine), such as a slot machine and the like.

The present invention is applicable to designing and gaming processes of various gaming machines other than the pachinko gaming machine.

What is claimed as new and desired to be secured by Letters Patent of the United States is:

1. A pachinko machine simulation program for allowing a computer to execute:
a first displaying step of displaying at least one portion of a virtual pachinko machine on a display screen of the computer, based upon gaming board information relating to a gaming board having a predetermined gaming area and a gaming element arranged on the gaming board;
an altering step of making said gaming board information alterable;
a material parameter setting step of setting parameters relating to materials of said gaming board and said gaming element;
an orbit calculating step of calculating an orbit on the gaming board of a gaming ball to be launched onto said gaming board based upon said parameters and said gaming board information; and
a second displaying step of displaying on said gaming board the orbit of the gaming ball calculated in said orbit calculating step.

2. The pachinko machine simulation program according to claim 1,
wherein
said parameters include a coefficient of friction or a coefficient of restitution between the gaming ball and said gaming element.

3. The pachinko machine simulation program according to claim 1, further comprising:
a parameter altering step of making said parameters alterable.

4. The pachinko machine simulation program according to any of claims 1 to 3,
wherein
said gaming board information includes any one of a launching velocity of a gaming ball, a tilt angle of said gaming board, and a shape, a position and a size of said gaming element.

5. A recording media readable by a computer, having the pachinko machine simulation program according to claim 1 recorded therein.

6. A simulator comprising:
storage means for storing gaming board information relating to a gaming board having a predetermined gaming area and a gaming element arranged on the gaming board;
display means for displaying at least one portion of a virtual pachinko machine based upon said gaming board information;
alteration means for altering said gaming board information;
material parameter setting means for setting parameters relating to materials of said gaming board and said gaming element;.
calculation means for calculating an orbit on the gaming board of a gaming ball to be launched onto said gaming board based upon said parameters and said gaming board information; and
simulation means for simulating on said display means the orbit of the gaming ball calculated by said calculation means.

7. The simulator according to claim 6, further comprising:
parameter alteration means for altering said parameters.

8. A pachinko gaming machine comprising:
storage means for storing gaming board information relating to a gaming board having a predetermined gaming area and a gaming element arranged on the gaming board;
display means for displaying at least one portion of a virtual pachinko machine based upon said gaming board information;
alteration means for altering said gaming board information;
material parameter setting means for setting parameters relating to materials of said gaming board and said gaming element;
calculation means for calculating an orbit on the gaming board of a gaming ball to be launched onto said gaming board based upon said parameters and said gaming board information; and
simulation means for simulating on said display means the orbit of the gaming ball calculated by said calculation means.

9. The pachinko gaming machine according to claim 8, further comprising:
parameter alteration means for altering said parameters.

10. A game network system having a server for carrying out control relating to a game, and a gaming terminal connected to said server through a network,
wherein
said server comprises: storage means for storing, gaming board information relating to a gaming board having a predetermined gaming area and a gaming element arranged on the gaming board, and parameters relating to materials of said gaming board and said gaming element; means for displaying at least one portion of a virtual pachinko machine based upon said gaming board information stored in said storage means on a display screen of said gaming terminal; calculation means for calculating an orbit on the gaming board of a gaming ball to be launched onto said gaming board based upon said gaming board information and said parameters stored in said storage means; and simulation means for simulating the orbit of the gaming ball calculated by said calculation means on the display screen of said gaming terminal, and
said gaming terminal comprises: setting-alteration means for setting or altering said gaming board information and said parameters stored in said storage means of said server; and said display screen.

11. A simulation program for allowing a computer to execute:
a member information setting step of setting member information relating to respective members constituting a gaming machine;
an arranging step of arranging a simulated gaming machine in a virtual space based upon the member information set in said member information setting step;
an orbit calculating step of calculating an orbit of a simulated gaming medium flowing down in the simulated gaming machine in the virtual space based upon said member information; and
a displaying step of displaying an image in which the simulated gaming medium flows down in the simulated gaming machine with the display means based upon the orbit of the simulated gaming medium calculated in said orbit calculating step.

12. The simulation program according to claim 11,
wherein
in said member information setting step, numeric value information relating to a coefficient of restitution or a coefficient of friction is settable for each of the members.

13. The simulation program according to claim 11,
wherein
in said member information setting step, a layout position of a member is settable for each of the members.

14. The simulation program according to claim 11,
wherein
in said member information setting step, a form of a member is settable for each of the members.

15. The simulation program according to claim 11, further comprising:
a gaming medium information setting step of setting information relating to said simulated gaming medium.

16. The simulation program according to claim 11, further comprising:
an accumulating step of accumulating a predetermined statistical value relating to the result caused by the simulated gaming medium to the simulated gaming machine based upon the orbit of the simulated gaming medium calculated in said orbit calculating step; and
an accumulated result displaying step of displaying the result accumulated in said accumulating step.

17. The simulation program according to claim 16,
wherein
in said orbit calculating step, the orbit of the simulated gaming medium on the gaming board placed in the simulated gaming machine can be calculated,
the program further comprising a winning determining step of determining a passage of a simulated gaming medium through a predetermined winning determination area on said gaming board as a winning,
wherein
in said accumulating step, the ratio of the number of determined winnings to the total number of the simulated gaming media that flow down in said gaming board is calculated.

18. The simulation program according to claim 17,
wherein
a plurality of said winning determination areas are prepared,
the program further comprising a point setting step of setting a point for each of said winning determination areas,
wherein
in said accumulating step, points are added in accordance with a winning determination area through which a simulated gaming medium has passed so that an accumulated value is calculated, while the ratio of the accumulated value of the points to the total number of the simulated gaming media that flow down in the gaming board is also calculated.

19. A simulator comprising:
storage means for storing member information relating to respective members constituting a gaming machine;
operation means capable of carrying out operations;
setting means for setting the member information based upon the operations by said operation means;
arrangement means for arranging a simulating gaming machine in a virtual space based upon the member information set by said setting means;
orbit calculation means for calculating an orbit of a simulated gaming medium flowing down in the simulated gaming machine in the virtual space based upon said member information;
display means for displaying an image; and
display control means for displaying an image in which a simulated gaming medium flows down in the simulated gaming machine with the display means based upon the orbit of the simulated gaming medium calculated by said orbit calculation means.
